(19) United States
(12) Patent Application Publication
(10) Pub. No.: US 2015/0331507 A1
(43) Pub. Date: Nov. 19, 2015

(54) METHOD AND APPARATUS FOR EMBEDDING RADIATED ELEMENTS IN A TOUCH PANEL

(71) Applicant: MOTOROLA SOLUTIONS, INC, SCHAUMBURG, IL (US)

(72) Inventors: AVIV SHACHAR, RAMAT-GAN (IL); SHIMON BARNESS, MATAN (IL); GIORGI BIT-BABIK, PLANTATION, FL (US); ANTONIO FARAONE, FORT LAUDERDALE, FL (US)

(73) Assignee: MOTOROLA SOLUTIONS, INC, SCHAUMBURG, IL (US)

(21) Appl. No.: 14/277,212

(22) Filed: May 14, 2014

(51) Int. Cl. G06F 3/041

(52) U.S. Cl. CPC G06F 3/041

(57) ABSTRACT

Radiated elements are embedded in in a touch panel that includes a plurality of layers including at least one conductive layer and at least one silver layer. The plurality of layers are configured a stack up configuration. The touch panel also includes a border region around the perimeter of each of the at least one conductive layer and the at least one silver layer. The border region is configured to function as an electro static discharge protector and all portions of the border region are configured to house an arbitrary pattern of antennas

### BACKGROUND OF THE INVENTION

In many electronic devices, such as portable communication devices, touch panel displays (touch screen) present information to a user and also receive input from the user. A touch screen offers intuitive inputting for a computer or other data processing devices. It is especially useful in portable communication devices where other input devices, such as a keyboard and a mouse, are not easily available. There are many different types of touch sensing technologies, including capacitive, resistive, infrared, and surface acoustic wave. All of these technologies sense the position of touches on a screen.

A capacitive touch panel may be used, for example, in mobile devices such as personal digital assistants (PDA), smartphones, and tablets. New designs of mobile devices with the capacitive touch panels typically aim to increase the size of the visual displays while reducing the overall sizes of these devices. Accordingly, designers of mobile devices with the capacitive touch panels have to be creative in finding locations for housing other components in the devices. For example, one or more antennas may have to be located in the vicinity of a capacitive touch panel. A current solution forms a metalized border area around a conductive transparent layer (for example, an Indium Tin Oxide (ITO) layer) of the touch panel and removes a portion of the metalized border area that is unused by electrodes in order to house an antenna. Hence, the antenna in this solution is housed on the ITO and the antenna may only be housed in a predefined section (i.e., a section unused by electrodes) in the metalized border. This solution therefore restricts placement of the antenna on the metalized border and its placement of the antenna on the ITO may affect radiation performance and isolation.

Accordingly, there is a need for a method and apparatus for embedding radiated elements in the touch panel.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a touch panel used in accordance with some embodiments.

FIGS. 2A through 2H are block diagrams of different types of antenna configurations housed in different portions of a border region of a touch panel in accordance with some embodiments.

FIG. 3 is a block diagram that illustrates that isolation between the silver layers is generated by the capacitance in accordance with some embodiments.

FIGS. 4A and 4B illustrate visual displays of communication devices with antennas housed in a perimeter around a touch panel in accordance with some embodiments.

FIG. 5 is a block diagram of a device incorporating a touch panel in accordance with some embodiments.

FIG. 6 illustrates a flowchart of a method of in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for embedding radiated elements in the touch panel. The touch panel includes a plurality of layers including at least one conductive layer and at least one silver layer. The plurality of layers is configured as a stack up configuration. The touch panel also includes a border region around the perimeter of each of the at least one conductive layer and the at least one silver layer. The border region is configured to function as an electro static discharge protector and any portion of the border region is configured to house any configuration of a set of antennas.

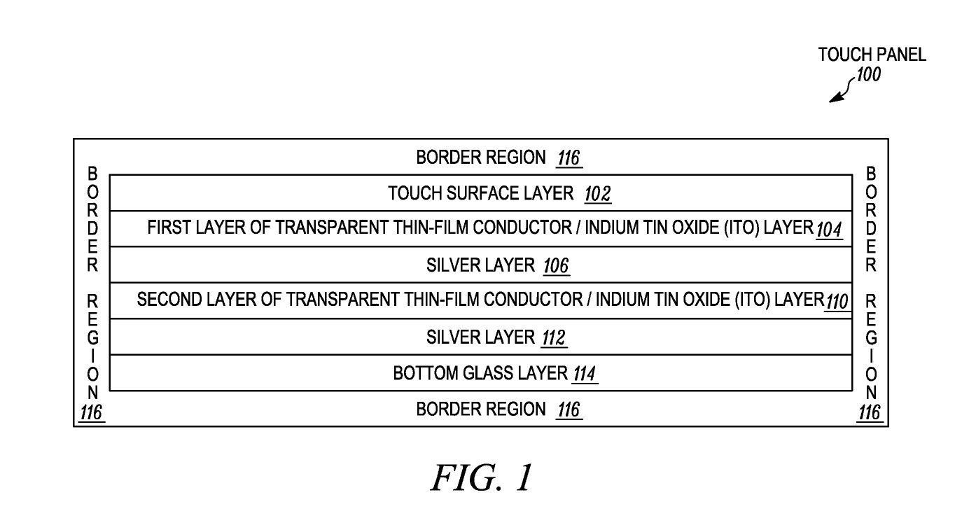

FIG. 1 is a block diagram of a touch panel used in accordance with some embodiments. Touch panel 100 may use any touch sensing technology where a metalized border is configured around at least one conductive layer and at least one silver layer in the touch panel. For example, touch panel 100 may be a capacitive touch panel with a transparent touch surface layer 102, a first layer of transparent thin-film conductor 104, a layer of silver 106 positioned under the first layer of transparent thin-film conductor 104, a second layer of transparent thin-film conductor 110, a layer of silver 112 positioned under the second layer of transparent thin-film conductor 110 and a bottom glass layer 114. Accordingly, the layers of touch panel 100 are configured in a stack-up configuration, wherein the layers in the stack up configuration may be sealed with an optically clear adhesive. It should be noted that touch panel 100 may include other layers that are not shown for ease of illustration.

Touch panel 100 may be used in, for example, mobile communication devices of varying dimensions. Non-limiting examples of the mobile communication devices may include portable or handheld devices such as personal digital assistants (PDA), smartphones, tablets, and the equivalents thereof Therefore, the sizes of the touch panels in different communication devices may vary based on the specific dimensions of each communication device.

Touch surface layer 102 may be an insulator such as glass. First transparent thin-film conductor 104 and second transparent thin-film conductor 110 may be a thin layer of Indium Tin Oxide (ITO). First layer of transparent thin-film conductor 104 may also be referred to herein as ITO layer 104 or conductive ITO layer 104 and second layer of transparent thin-film conductor 110 may also be referred to as ITO layer 110 or conductive ITO layer 110. The patterns on the ITO layers 104 and 110 form a grid of capacitors, wherein electric fields of the capacitors are projected through top surface layer 102. Accordingly, when a position on top surface layer 102 is touched with a touching element, for example, a finger or stylus, the touching element couples with the electric fields and this coupling changes the capacitance of capacitors in the vicinity of the touching element. An algorithm associated with touch panel 100 converts the changes in capacitance into a location along the X and Y axis of the capacitive touch panel.

In addition to the ITO layers, touch panel 100 may also include layers of silver (i.e., layers 106 and 112) under each of ITO layers 104 and 110. ITO layer 104, silver layer 106, and ITO layer 110 and silver layer 112 may be used as a ground plane. A metalized border region 116 made of, for example, a strip of silver ink, may also be added around the perimeter of touch panel 100 to protect against electro static discharge. The strip of silver ink added around the perimeter of touch panel 100 allows for electro static discharge through the strip and prevents damage associated with electro static discharge through the ITO layers. Accordingly, border region 116 may be positioned around the perimeter of ITO layer 104, ITO layer 110, silver layer 106 and silver layer 112. In addition to functioning as an electro static discharge protector, in accordance with some embodiments, any portion of border region 116 may be configured to house any configuration of a set of antennas, wherein any and/or all portions of border region 116 may be used to house any configuration of one or more antennas in a set of antennas. In other words, configurations of one or more antennas may be housed in any and/or all portions of border region 116.

The antenna structure housed on border region 116 may be, for example, a slot antenna configuration. The layers of touch panel 100 may be aligned (i.e., the layers may be stacked-up) so that the same antenna pattern (also referred to herein as a first antenna pattern) is incorporated in one or more layers of touch panel 100. Each of ITO layer 104, silver layer 106, and ITO layer 110 and silver layer 112 may be coated on an optical substrate (dielectric material). During the slot fabrication on border region 116, clearance may be provided (by, for example, masking) at each of ITO layer 104, silver layer 106, and ITO layer 110 and silver layer 112. Accordingly, a slot shaped in border region 116 goes across the touch panel layers (stack-up) such that the slot includes only dielectric material and does not include any ITO, at ITO layer 104 and ITO layer, or metal, at silver layer 106, and silver layer 112.

The layers of touch panel 100 may also be aligned so that one or more layers of touch panel 100 may have a selective antenna pattern. In other words, the same clearance is maintained across the layers in order to generate a desired antenna pattern across the stack-up of the layers. Border region 116 may also be used to house other antenna configurations, for example, a wireless antenna configuration, although such a configuration may not be optimal because touch panel 100 may be close to a printed circuit board and/or a chassis on the communications device.

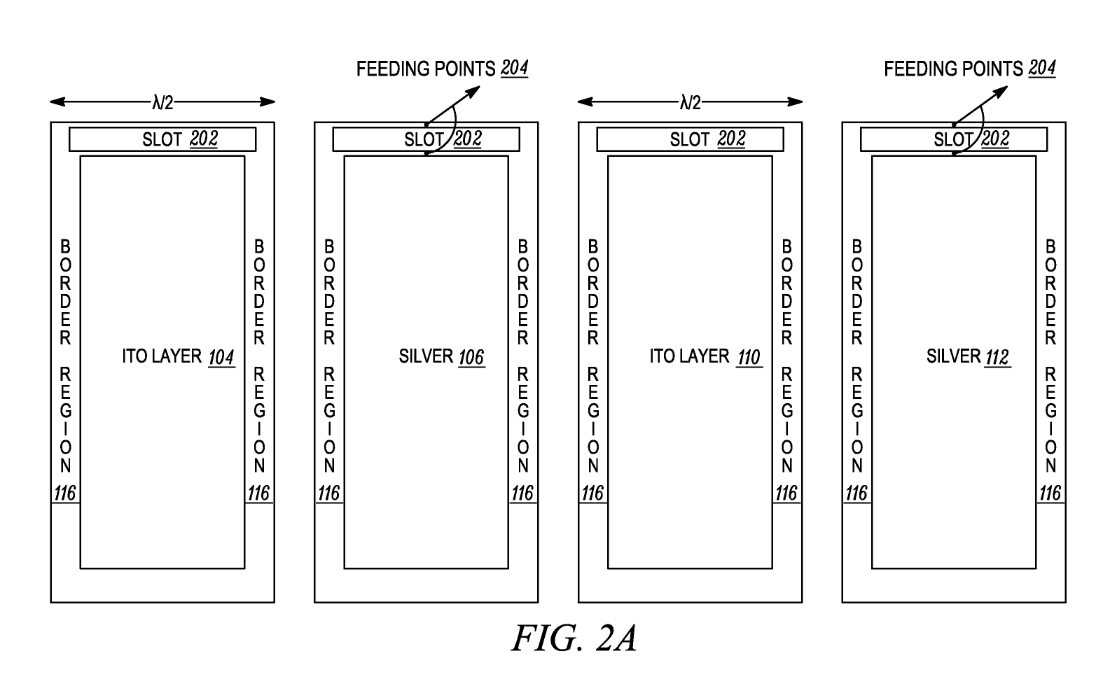

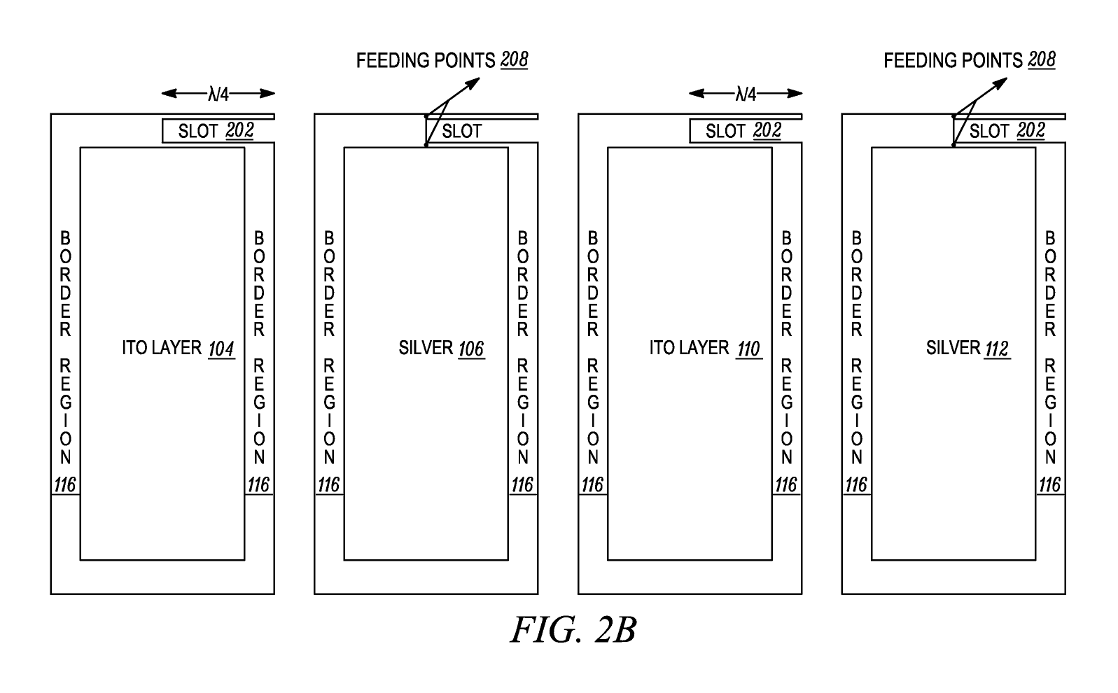

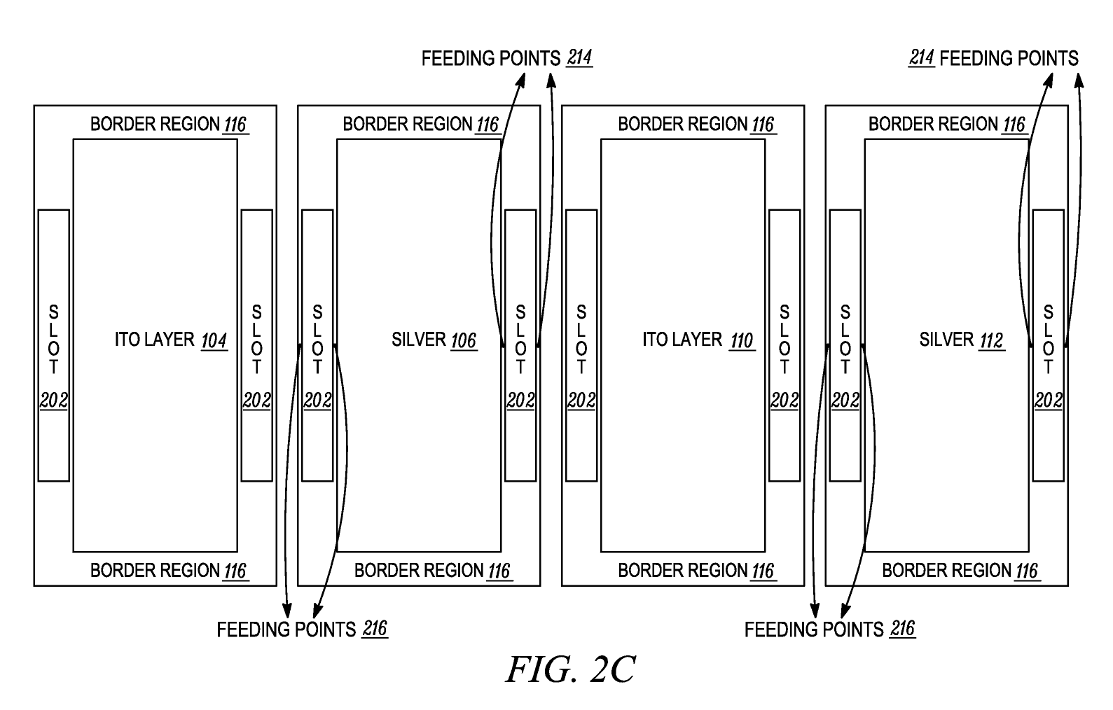

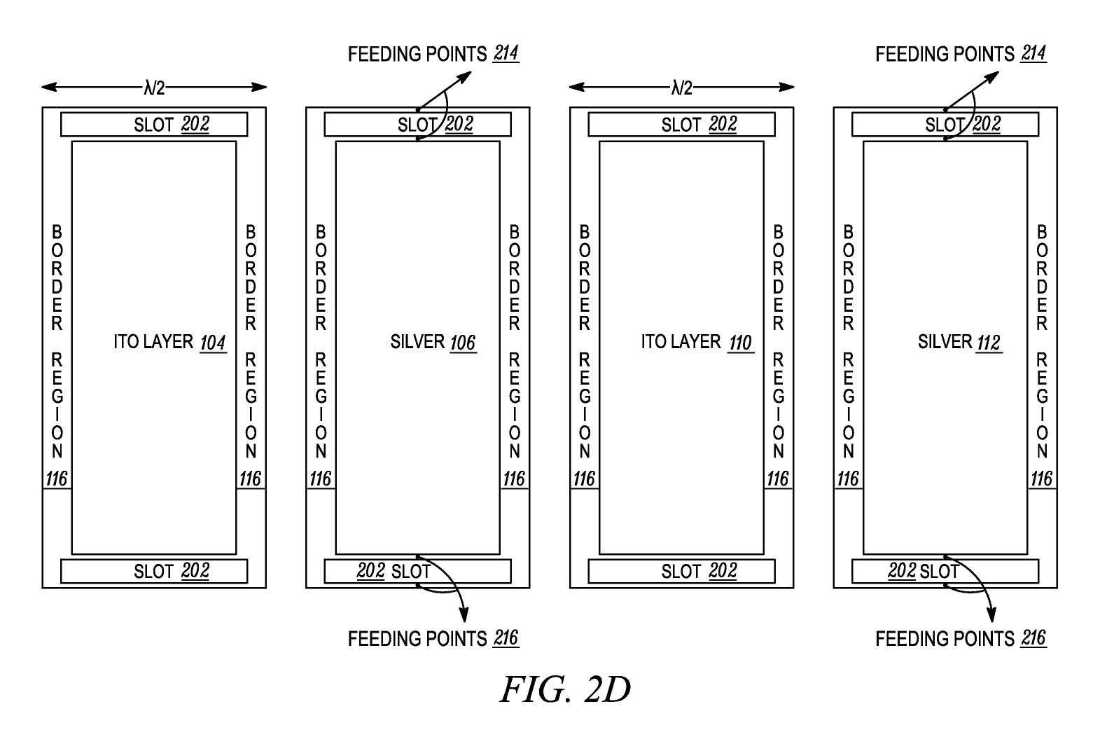

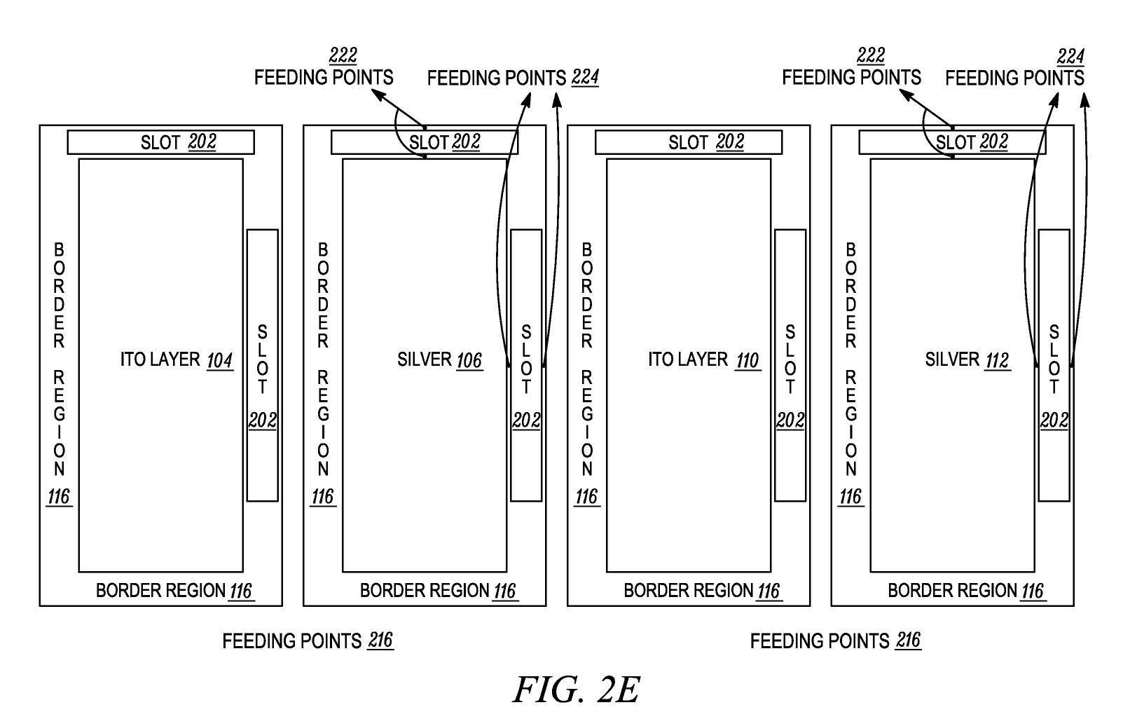

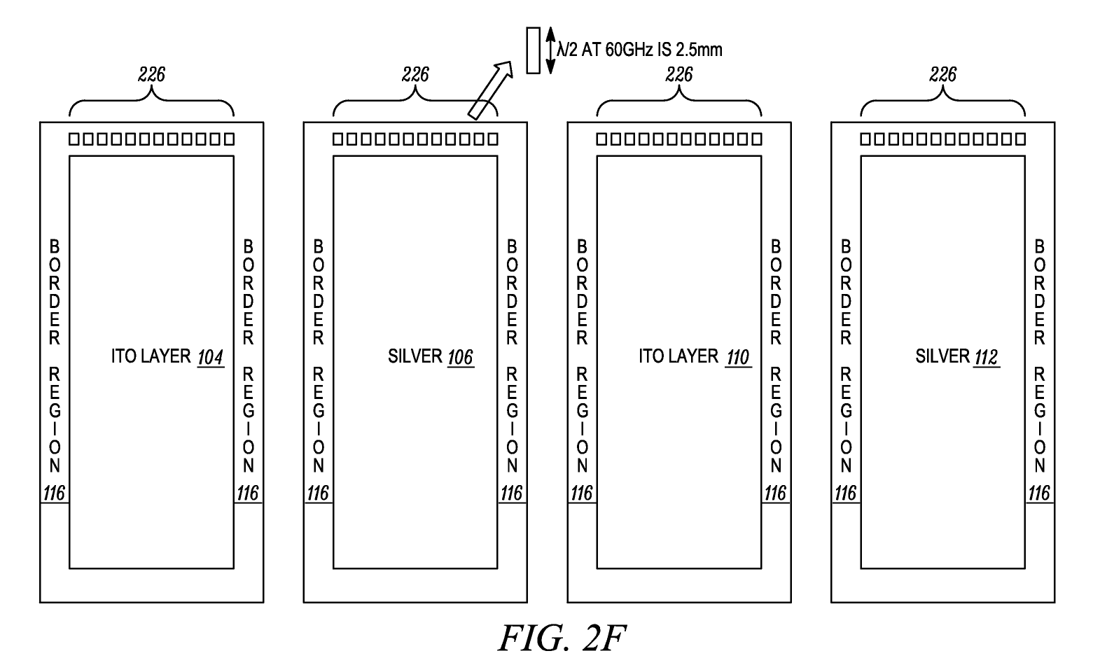

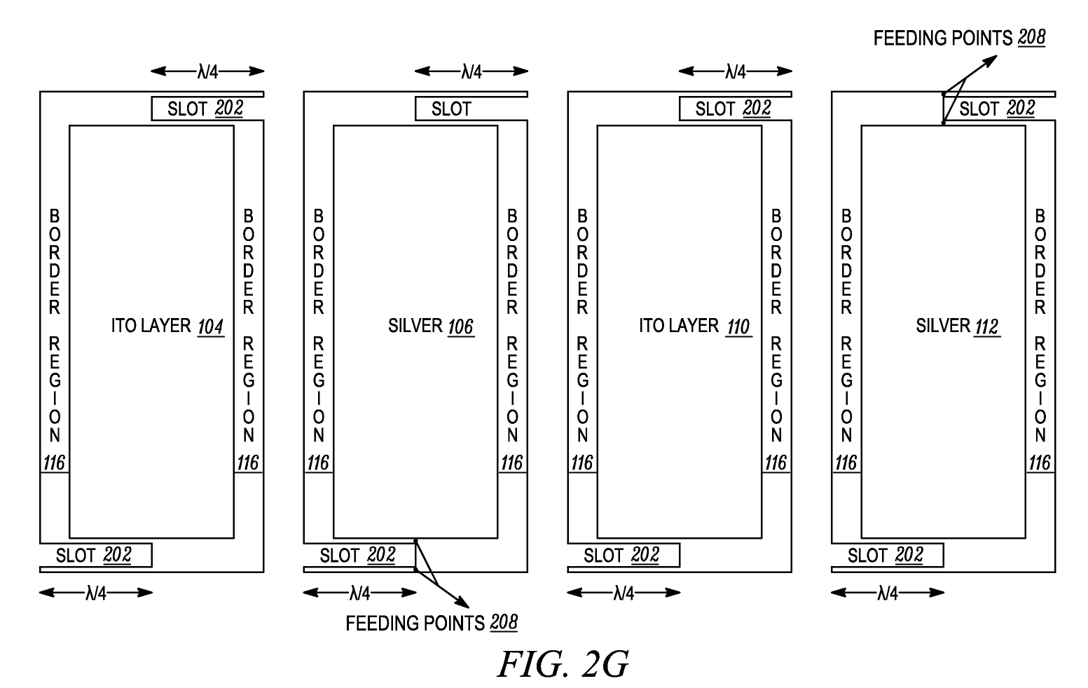

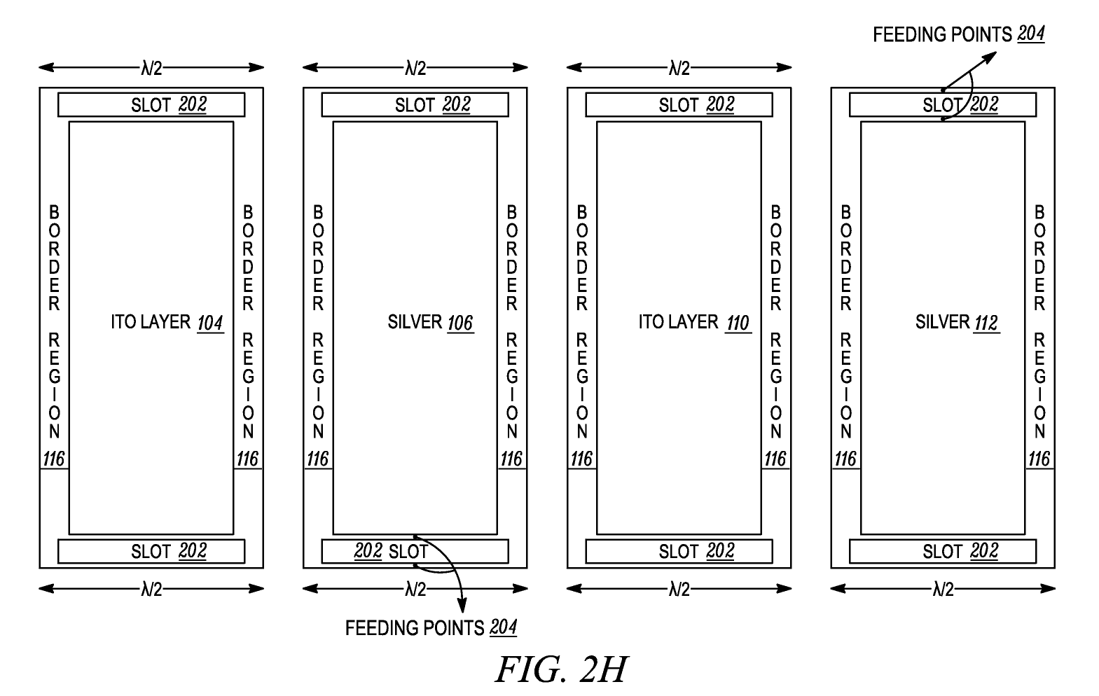

FIGS. 2A through 2H are block diagrams illustrating non-limiting examples of different types of antenna configurations housed in different regions on a border region of a touch panel in accordance with some embodiments. For ease of illustration, the layers in the touch panels shown in FIGS. 2A through 2H are adjacent to each other rather than in a stack-up configuration. Although each of FIGS. 2A through 2H may have other layers and configurations, each of FIGS. 2A through 2H may include the same layers and configuration as FIG. 1 and may be considered to be in a stack-up configuration that is similar to the configuration of FIG. 1. FIGS. 2A through 2H show how border region 116 is formed around the perimeter of each of ITO layers 104 and 110 and silver layers 106 and 112.

FIG. 2A is a block diagram of a slot dipole type antenna housed in a border region of a touch panel configuration in accordance with some embodiments. As noted above, touch panel 100 includes a border region 116 formed, for example, with a strip of silver. Slot 202 (also referred to herein as dielectric area 202) shaped across each of ITO layers 104 and 110 and silver layers 106 and 112 include only dielectric material. Therefore, at ITO layers 104 and 110, dielectric area 202 does not include any ITO, and at silver layer 106 and 112, dielectric area 202 does not include any metal. At each of ITO layers 104 and 110 and silver layer 106 and 112, the sections labeled as ITO layers 104 and 110 and silver layer 106 and 112 are transparent touch panel optical areas. A half-wave dipole type slot antenna may therefore be housed in dielectric area 202. The antenna feeding may be performed through mechanical holes in specific layers, for example, in a Polyethylene Terephthalate (PET) Hard Coat Layer (not shown) and Optically Clear Adhesive 3 layer (not shown) in the touch panel configuration. Antenna feeding points 204 may also be positioned in border region 116. According to certain feeding methods, silver layer 112 may be used as a galvanic connection to excite the slot antenna.

FIG. 2B is a block diagram of a slot monopole type antenna housed in a border region of a touch panel configuration in accordance with some embodiments. The touch panel configuration of FIG. 2B is similar to that of FIG. 2A. A quarter wavelength monopole antenna may therefore be housed in slot/dielectric area 202. The antenna feeding points 208 are positioned in border region 116.

FIGS. 2C and 2D are block diagrams of multiple input multiple output (MIMO) antennas housed in a border region of a touch panel configuration in accordance with some embodiments. The touch panel configurations of FIGS. 2C and 2D are similar to that of FIGS. 2A AND 2B. The MIMO antenna configuration exploits space dimensions on border region 116 to improve the antenna capacity, range and reliability. Accordingly, two half-wave dipole type slot antennas may therefore be housed in slot/dielectric area 202. The respective antenna feeding points 214 and 216 are positioned in border region 116.

FIG. 2E is a block diagram of Right Hand Circularly Polarized (RHCP) based dipole antennas housed in a border region of a touch panel configuration in accordance with some embodiments. The touch panel configuration of FIG. 2E is similar to that of FIGS. 2A-2D. RHCP based dipole antennas are housed in slot/dielectric area 202. The antenna feeding points 222 and 224 are positioned in border region 116. RHCP based dipole antennas are two linear antennas with a ninety degree difference between the antennas. Although RHCP based dipole antennas are shown, the antennas could also be Left Hand Circularly Polarized (LHCP) antennas that are positioned on the left side of the touch panel.

FIG. 2F is a block diagram of an antenna array used in accordance with some embodiments. FIG. 2F shows an example for a linear array of 1×12 based vertical slot antennas 226 (also known in the art for beam scanning and considered to be smart antennas). The antenna array 226 may operate, for example, according to the Wireless Gigabit Alliance (WiGig) IEEE 802.1 lad standard. For any IEEE standards recited herein, contact the IEEE at IEEE, 445 Hoes Lane, PO Box 1331, Piscataway, N.J. 08855-1331, USA. Because the WiGig spectrum is 60 GHz, the slot length for each antenna in the array may be, for example, about 2.5 mm in order to implement an arbitrary linear array across border region 116. The linear array of slot antennas 226 may be a 1×N array of antennas, wherein N represents a number of antennas that may be included in the array. Besides the example of vertical slot antennas shown in FIG. 2F, a linear array of horizontal slot antennas may be supported as well. The antenna feeding may be performed through mechanical holes in specific layers. The antenna feeding points 204 may also be positioned in border region 116. According to certain feeding methods, silver layer 112 may be used as a galvanic connection to excite the slot antenna.

FIG. 2G is a block diagram of two slot monopole type antennas housed in a border region of a touch panel configuration in accordance with some embodiments. The touch panel configuration of FIG. 2G is similar to that of FIG. 2A-2F. Two quarter wavelength monopole antennas are shown be housed in slot/dielectric area 202. The antenna feeding points 208 are positioned in border region 116.

FIG. 2H is a block diagram of two slot dipole type antennas housed in a border region of a touch panel configuration in accordance with some embodiments. The touch panel configuration of FIG. 2H is similar to that of FIG. 2A-2G. Two half wavelength dipole antennas are shown be housed in slot/dielectric area 202. The antenna feeding points 204 are positioned in border region 116.

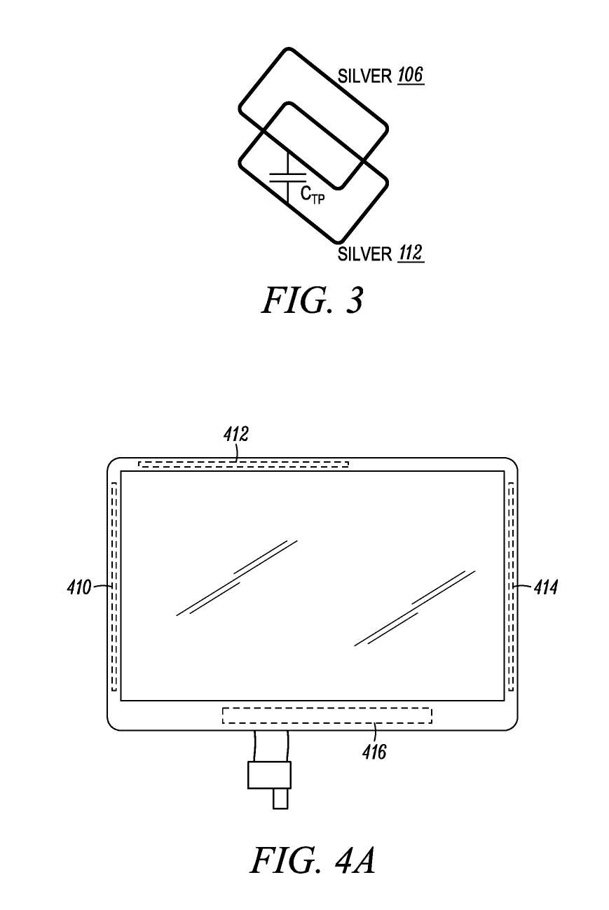

There may be no direct galvanic connection between silver layers 106 and 112. Hence, the feeding points 204 and 208 perform separately at each silver layer as shown at FIGS. 2G and 2H. Due to the lack of galvanic relation between silver layers 106 and 112, they only stacked together and generate capacitance. Hence the isolation between silver layers 106 and 112 is generated by the capacitance (Ctp) as shown in FIG. 3 and may minimize the correlation-coefficient (as required, for example, in a MIMO system).

In each of the antennas shown in FIGS. 2A through 2H, antenna feeding may be performed by, for example, radio frequency springs, pogo-pins, bonding die, or excitation by coupling. The transmission line could be, for example, a coaxial cable, strip-line or micro-strip.

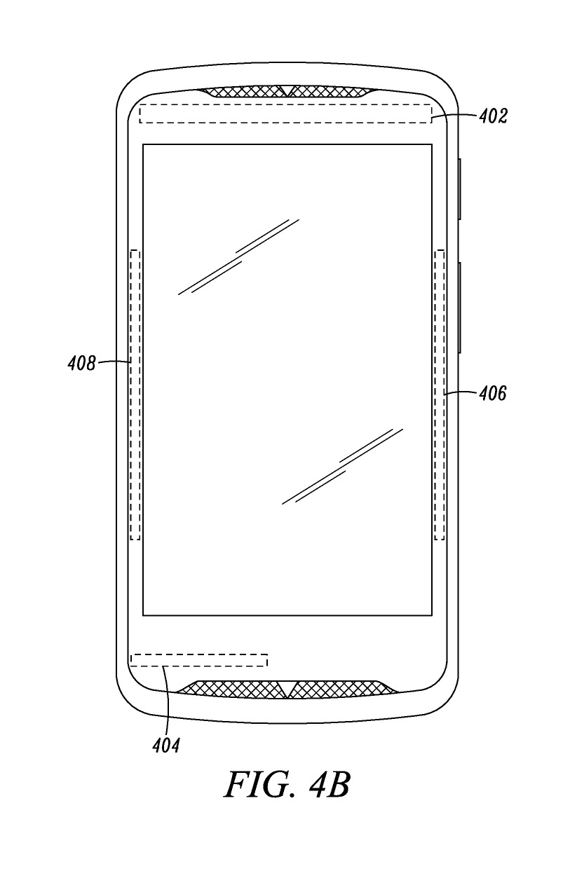

FIGS. 4A and 4B illustrate visual displays of communication devices with antennas housed in a perimeter around a touch panel in accordance with some embodiments. In FIG. 4A, LHCP based dipole antennas 410 and 412 and two dipole antennas 414 and 416 may be positioned in a dielectric area around the perimeter of a touch panel. In 4B, half-wave dipole type slot antenna 402, a quarter wavelength monopole antenna 404, and a MIMO configuration with two half-wave dipole type slot antennas 406 and 408 may be positioned in a dielectric area around the perimeter of a touch panel.

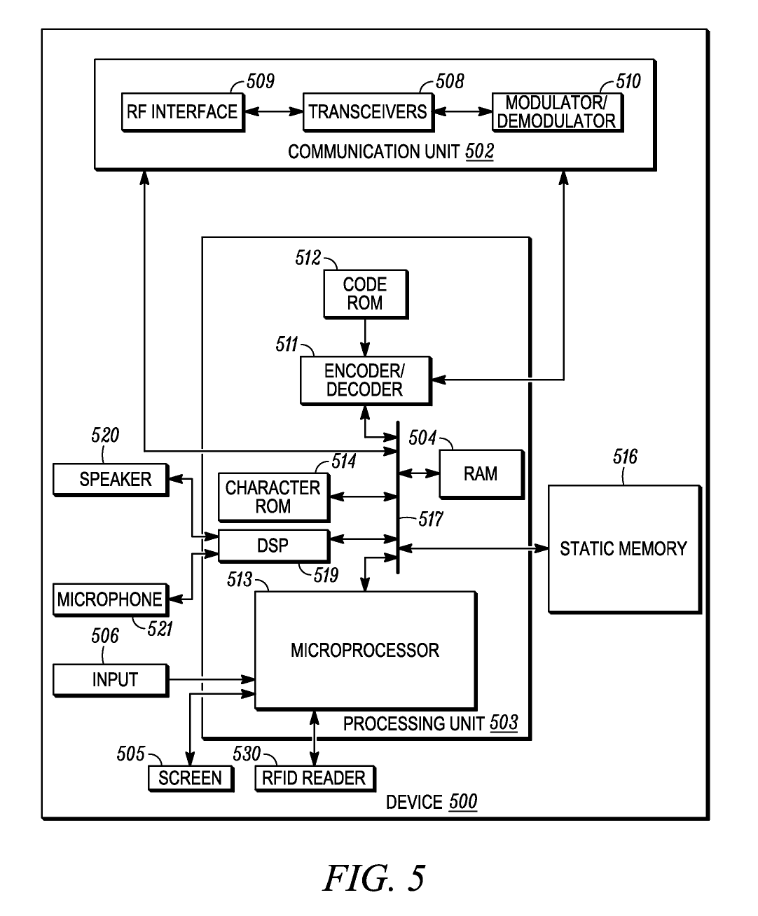

FIG. 5 is a block diagram of a device incorporating a touch panel in accordance with some embodiments. Device 500 includes a communications unit 502 coupled to a common data and address bus 517 of a processing unit 503. Device 500 may also include one or more peripherals, for example, a radio frequency identifier (RFID) reader 530 configured to scan RFID tags or badges. Device 500 may also include an input unit (e.g., keypad, pointing device, etc.) 506, an output transducer unit (e.g., speaker) 520, an input transducer unit (e.g., a microphone) (MIC) 521, and a display screen 505, each coupled to be in communication with the processing unit 503. Display screen 505 may be a touch screen incorporating the touch panel described herein.

Processing unit 503 may include an encoder/decoder 511 with an associated code read only memory (ROM) 512 for storing data for encoding and decoding voice, data, control, or other signals that may be transmitted or received by device 500. Processing unit 503 may further include a microprocessor 513 coupled, by the common data and address bus 517, to the encoder/decoder 511, a character ROM 514, a random-access memory (RAM) 504, and a static memory 516. The character ROM 514 may store code for decoding or encoding data such as control, request, or instruction messages, channel change messages, and/or data or voice messages that may be transmitted or received by device 500. The processing unit 503 may also include a digital signal processor (DSP) 519, coupled to the speaker 520, the microphone 521, and the common data and address bus 517, for operating on audio signals received from one or more of the communications unit 502, the static memory 516, and the microphone 521.

Communications unit 502 may also include a wired network connection. Communications unit 502 may also include an (radio frequency) RF interface 509 configurable to communicate with network components, and other user equipment within its communication range. Communications unit 502 may include one or more broadband and/or narrowband transceivers 508, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications.

Communications unit 502 may also include one or more local area network or personal area network transceivers such as wireless local area network transceiver perhaps operating in accordance with an IEEE 802.11 standard (e.g., 802.11a, 802.11b, 802.11g, 802.11ad), or a Bluetooth transceiver. The transceivers may be coupled to a combined modulator/demodulator 510 that is coupled to the encoder/decoder 511.

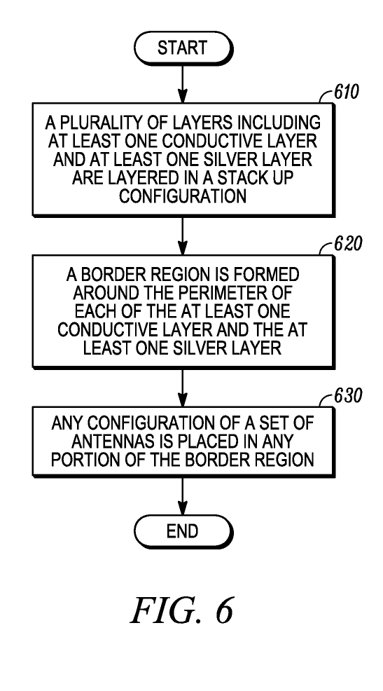

FIG. 6 illustrates a flowchart of a method for embedding radiated elements in the touch panel in accordance with some embodiments. At 610, a plurality of layers including at least one conductive layer and at least one silver layer are layered in a stack up configuration. At 620, a border region is formed around the perimeter of any configuration of a set of antennas is placed in any portion of the border region each of the at least one conductive layer and the at least one silver layer. At 630, any configuration of a set of antennas is placed in any portion of the border region. Accordingly, the border region is configured to function as an electro static discharge protector and any portion of the border region is configured to house any configuration of a set of antennas.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A touch panel, comprising:
a plurality of layers including at least one conductive layer and at least one silver layer, wherein the plurality of layers are configured in a stack up configuration; and
a border region around the perimeter of each of the at least one conductive layer and the at least one silver layer, wherein the border region is configured to function as an electro static discharge protector and any portion of the border region is configured to house any configuration of a set of antennas.

2. The touch panel of claim 1, wherein the configuration of the set of antennas comprises at least one of a dipole type antenna, a monopole type antenna, a multiple input multiple output (MIMO) antenna, an array of antennas, and a circularly polarized antenna.

3. The touch panel of claim 1, wherein the border region is comprised of silver ink.

4. The touch panel of claim 1, wherein at least one antenna in the set of antennas is a slot antenna.

5. The touch panel of claim 1, wherein the at least one conductive layer is a layer of Indium Tin Oxide (ITO).

6. The touch panel of claim 1, wherein the at least one conductive layer and the at least one silver layer function as a ground plane.

7. The touch panel of claim 1, wherein the at least one silver layer functions to increase isolation between antennas housed in the border region.

8. The touch panel of claim 1, wherein the plurality of layers are sealed together with an optically clear adhesive.

9. The touch panel of claim 1, wherein the at least one conductive layer and the at least one silver layer are aligned and are configured to incorporate a first antenna pattern.

10. The touch panel of claim 1, wherein the at least one conductive layer and the at least one silver layer are aligned and are configured to incorporate a selective antenna pattern.

11. The touch panel of claim 1, wherein the at least one conductive layer and the at least one silver layer are coated on an optical substrate such that when a slot for an antenna is fabricated on the border region around the perimeter of the at least one conductive layer and the at least one silver layer, the slot includes dielectric material.

12. A communications device, comprising:
a touch panel including:
a plurality of layers including at least one conductive layer and at least one silver layer, wherein the plurality of layers are configured in a stack up configuration; and
a border region around the perimeter of each of the at least one conductive layer and the at least one silver layer, wherein the border region is configured to function as an electro static discharge protector and any portion of the border region is configured to house any configuration of a set of antennas; and
a processor configured to process information transmitted and received via antennas housed in the border region.

13. A method, comprising:
layering a plurality of layers including at least one conductive layer and at least one silver layer in a stack up configuration;
forming a border region around the perimeter of each of the at least one conductive layer and the at least one silver layer; and
housing a configuration of a set of antennas in the border region,
wherein the border region is configured to function as an electro static discharge protector and any portion of the border region is configured to house any configuration of the set of antennas.

14. The method of claim 13, further comprising sealing the plurality of layers together with an optically clear adhesive.

15. The method of claim 13, further comprising aligning the at least one conductive layer and the at least one silver layer and incorporating a first antenna pattern in each of the aligned conductive layer and silver layer.

16. The method of claim 13, further comprising aligning the at least one conductive layer and the at least one silver layer and incorporating a selective antenna pattern in the aligned conductive layer and silver layer.

17. The method of claim 13, further comprising coating the at least one conductive layer and the at least one silver layer on an optical substrate such that when a slot for an antenna is fabricated on the border region in the at least one conductive layer and the at least one silver layer, the slot includes dielectric material.
